(19) United States
(12) Patent Application Publication
(10) Pub. No.: US 2008/0307786 A1
(43) Pub. Date: Dec. 18, 2008

(54) Multi-Stable Actuator Based on Shape Memory Alloy and Touch-Sensitive Interface Using Same

(75) Inventors: Moustapha Hafez, Paris (FR); Jean-Marc Alexandre, Antony (FR)

Correspondence Address: PEARNE & GORDON LLP, 1801 EAST 9TH STREET, SUITE 1200, CLEVELAND, OH, 44114-3108, US

(73) Assignee: Commissariat A L'Energie Atomique, Paris (FR)

(21) Appl. No.: 10/579,320

(22) PCT Filed: Nov. 15, 2004
(86) PCT No.: PCT/FR04/50586

§ 371 Date: May 16, 2006

(30) Foreign Application Priority Data
Nov. 17, 2003 (FR) 0350839

(51) Int. Cl. F03G 7/06

(52) U.S. Cl. 60/527; 337/102

(57) ABSTRACT

The multistable actuator (10) includes:
a mobile part (12) intended to be moved between at least two stable positions,
movement means (14, 16) for moving the mobile part,
guide means (122, 186, 24, 246, 247, 248, 249) for guiding the movement of the mobile part (12), and
support means (20, 22, 28, 30, 246, 247, 248, 249) for holding the mobile part (12) in each of the stable positions that it occupies,

wherein the movement means (14, 16) are two opposing movement means made of a shape memory alloy.

Application in a tactile interface.

### TECHNICAL FIELD

This invention relates to the technical field of alloy-based actuators.

It relates to a multistable actuator, as well as an interface implementing at least one such actuator. This interface can be used to produce a tactile interface.

It is noted that an actuator is a device that is capable of generating a force intended to cause the movement of a mobile part.

It is noted that a multistable actuator is an actuator for which the mobile part moves between a plurality of positions each corresponding to a stable equilibrium state of the actuator.

It is noted that a bistable actuator is an actuator for which the mobile part moves between two positions each corresponding to a stable equilibrium state of an actuator.

It is noted that a tactile interface is a device enabling information to be detected by touch.

### PRIOR ART

Shape memory alloys are materials well known in a number of fields.

It is noted that a shape memory alloy is capable of transforming heat power into mechanical work. When it is heated, it can restore deformations on the order of 6 to 8% and generate very significant stresses. For example, a shape memory alloy-based object is capable of supporting 1000 times its mass. The functioning of shape memory alloys is based on mechanical and heat stresses of the material. There are one-way and two-way shape memory alloys. They behave as follows:
for an one-way shape memory alloy: the alloy is initially in a stable state (austenitic state) in a first stable shape; a stress is then applied to it at constant temperature, and it is deformed (martensitic state); if it is heated, it will return to the austenitic state, and thus to its initial shape, which it has remembered; an one-way shape memory alloy therefore has a single stable state, at high temperature;
for a two-way shape memory alloy: the material is “trained” by many applications of a thermal cycle analogous to the cycle described above for an one-way shape memory alloy; the external stresses applied are then replaced by stresses internal to the material; if the material is heated, it adopts a first stable state at high temperature (austenitic state) in which it has a first memorised stable shape; if the material is cooled, it adopts a second stable state at low temperature (martensitic state) in which it has a second memorised stable shape; a two-way shape memory alloy therefore has two stable states, one at high temperature, i.e. above a given temperature, and the other at low temperature, i.e. below said given temperature.

Document U.S. Pat. No. 6,242,841 discloses a stepper motor implementing driving devices made of a shape memory alloy, for rotating a photographic film around a film core in a photographic device case. Rings are stacked around the film core. The connection between the film core and the rings is a ratchet-type connection, created by ratchet teeth arranged opposite one another, on the film core and on each of the rings, respectively, and of which the shape is such that a rotation of the rings in one direction causes a corresponding rotation of the film core, while a rotation of the rings in the reverse direction does not cause a rotation of the film core. Each ring is connected to a shape memory alloy-based device and to a return spring. When the shape memory alloy-based devices are successively heated, they become deformed and rotate the rings, which in turn rotate the film core. The angular movement of the film core is the sum of the successive angular movements of the rings. When the shape memory alloy-based driving devices are no longer heated, they return to their previous shape. The rings are then successively returned to their previous position by the return springs. There is no corresponding movement of the film core.

Document U.S. Pat. No. 6,326,707 discloses an actuator comprising a plurality of rods placed parallel with respect to one another, and mutually connected by shape memory alloy-based wires, so that each wire connects the lower end of a rod to the upper end of the next rod. When the wires are heated, they are deformed so as to cause the movement of the rods, all in the same direction, so that the movement of the last rod corresponds to the cumulative movements of the preceding rods. A return spring connected to the free end of the last rod is drawn by the movement of the latter. When the shape memory alloy-based wires are cooled, the return spring brings the last rod to the initial position, and, in succession, all of the rods return to their initial positions.

The actuators described in these two documents have a disadvantage in that they do not have a device enabling the moved part(s) (ring for U.S. Pat. No. 6,242,841 and free end of the last rod for U.S. Pat. No. 6,326,707) to be immobilised in two or more stable positions. Indeed, they both have return springs, which are not made of a shape memory alloy, and which bring the mobile part(s) to the initial position when the heating of the shape memory alloy-based element(s) (driving devices for U.S. Pat. No. 6,242,841 and wire for U.S. Pat. No. 6,326,707) is stopped. To immobilise the mobile part(s), it would be necessary to keep the shape memory alloy-based elements heated. However, shape memory alloys have low heat conductivity (compared with that of copper). Therefore, the dissipated power is high. Consequently, their efficiency is very low, on the order of several percent, typically from 2 to 4%. It is noted that the efficiency of an actuator is defined as being the ratio of the mechanical work performed by the actuator to the electrical power provided to the actuator.

The document “Micro-actuation principles for high-resolution graphic tactile displays”, B. Brenner, S. Mitic, A. Vujanic, G. Popovic, in Proceedings of Eurohaptics, 2001, p. 55-58, describes a plurality of bistable actuators arranged in the form of an array comprising rows of actuators, and intended to be implemented in a graphic tactile screen. Each actuator combines a shape memory alloy-based wire and a spring of which the action opposes that of the wire. In a position corresponding to an initial state, the shape memory alloy-based wire is heated, causing the spring to retract, which in turn causes a blade acting as a support means to shift. In such an actuator array, each bistable actuator is individually active, but a single collective control means separates all of the blades of the same row, so that each actuator returns to its initial position by the action of its opposing spring. This document does not describe a multistable actuator.

### DISCLOSURE OF THE INVENTION

This invention aims to provide a solution to the disadvantages of actuators of the prior art, which implement one or more shape memory alloy-based element(s), such as those described above. This goal is achieved by a shape memory alloy-based bistable or multistable actuator.

According to a first aspect, the invention relates to a bistable or multistable actuator comprising:
a mobile part intended to be moved between at least two stable positions,
means for moving the mobile part,
means for guiding the movement of the mobile part, and
means for holding the mobile part in each of the stable positions that it occupies,

wherein the movement means are two opposing movement means, acting on each side of the mobile part, and each made of a shape memory alloy.

The two movement means can be made of the same shape memory alloy, or of different shape memory alloys.

For the shape memory alloy, titanium-based, copper-based or iron-based alloys can be used, such as, for example Ni—Ti, Ni—Ti—Cu, Cu—Al—Ni, Cu—Al—Be, Fe—Pt, Fe-Rd or Fe—Ni—Co—Ti.

The two movement means are preferably made of a one-way shape memory alloy. They can be combined in a single movement means with two-way effect.

The actuator of the invention can be an actuator with rotary movement, or an actuator with linear movement.

The guide means and the support means preferably constitute an integrated stepper mechanism.

According to a first embodiment, the guide means comprise at least one sliding bearing and the support means comprise projecting portion/recessed portion type contacts. Preferably, the projecting portions are half-spheres or half-cylinders, and the recessed portions are cones or grooves.

According to a second embodiment, the guide means comprise a plurality of elastic beams and the support means comprise projecting portion/recessed portion type contacts. Preferably, the projecting portions are flexible blades, and the recessed portions are slots.

According to a third embodiment, the guide means and the support means are pre-stressed and merged. The stability is thus obtained in two positions through the buckling of these guiding and support means.

According to an alternative common to the three embodiments, at least some of the elements of the mobile part, the movement means, the guide means and the support means are distinct elements assembled together.

According to a preferred alternative common to the three embodiments, the mobile part, the movement means, the guide means, and the support means are produced in the form of a one-piece shape memory alloy-based structure, of which at least the movement means have been subjected to a treatment giving them shape memory properties.

The one-piece structure is produced from a planar or relatively thin shape memory alloy-based part, for example by a cutting method.

The bistable or multistable actuator according to the invention has a certain advantage over the actuators of the prior art that have been described. Indeed, with the actuator of the invention, one of the shape memory alloy-based movement means is heated, causing the mobile part to move from a first stable position to a second stable position. The mobile part can then remain in this second stable position, owing to the support means, so that it is possible to stop heating the shape memory alloy-based movement means. Then, to move the mobile part again to another stable position (the first stable position for a bistable actuator or a third stable position for a multistable actuator), one or the other of the movement means is heated. It is then possible to stop heating it once the mobile part has reached said other stable position.

It can thus be seen that it is only necessary to heat the shape memory alloy-based movement means during the transient phases in which the mobile part moves between two stable positions. Since the heating of the shape memory alloy-based movement means is stopped when the mobile part is in a stable position, immobilised by the support means, the overall efficiency of the actuator is increased. This results in a reduction in the actuator operating costs because the presence of position sensors is no longer necessary.

According to a second aspect, the actuator according to the first aspect can be applied to specific devices, such as, for example those having an interface that comprises one or more multistable actuators according to the first aspect, and in which the actuators receive a command and produce a movement of a mobile part. Such an interface can be used in a tactile interface, in which the movement of mobile parts is detected by touch.

According to an alternative, it also includes heating means for heating the shape memory alloy-based movement means. These heating means can comprise heating resistors or laser radiation. The heating means preferably comprise Joule-effect elements connected to the elements.

### BRIEF DESCRIPTION OF THE DRAWINGS

The invention can be better understood from the following detailed description of specific embodiments of the invention, provided by way of illustration, and which are in no way limiting, in reference to the appended drawings, wherein:

FIG. 1A shows, in a front view, an actuator according to the first embodiment;

FIG. 1B shows, in a front view, a partial alternative for implementing the actuator of FIG. 1A;

FIG. 2 is analogous to FIG. 1, for an actuator according to the second embodiment;

FIG. 3 shows, in perspective, an interface comprising a plurality of actuators according to the second embodiment and a first alternative embodiment of the heating means;

FIG. 4 shows, in a front view, an actuator according to the third embodiment, wherein the mobile part is in a first stable position;

FIG. 5 is analogous to FIG. 4, showing the mobile part in another stable position;

FIG. 6 is a view analogous to that of FIG. 3, which shows, in perspective, a second alternative embodiment of the heating means.

### DETAILED DESCRIPTION OF SPECIFIC EMBODIMENTS

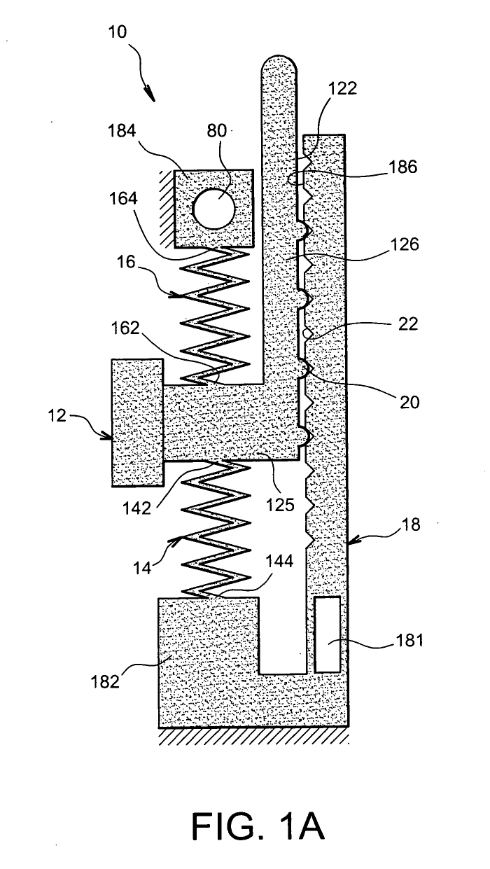

First, FIG. 1A shows a shape memory alloy-based actuator 10 according to a first alternative of the first embodiment of the first aspect of the invention.

The actuator 10 comprises a mobile part 12 and two movement means 14, 16 for moving the mobile part 12 with respect to a reference part 18, along a rectilinear path. The reference part 18 is stationary. The two movement means are connected to the mobile part 12 on either side thereof, and act in opposition, i.e. one of the movement means 14, 16 moves the mobile part 12 in one direction, and the other of the movement means 14, 16 moves the mobile part 12 in the other direction. In the example shown, the movement means 14, 16 are in the form of two springs capable of relaxing and contracting in the direction of the movement of the mobile part 12. They are connected by one of their ends 142, 162, respectively, to the mobile part 12. They are connected by the other of their ends 144, 164, respectively, to the reference part 18 of the actuator 10, such as, for example, to a base 182 or an attachment part 184 capable of being attached to the reference part 18 or to a stationary intermediate part forming part of the environment (not shown) of the actuator 10. In the example shown, the attachment part 184 comprises an attachment hole 80 for attachment by screwing using a screw (not shown) or by any other equivalent method. This attachment makes it possible to deform or pre-stress the two shape memory alloy-based springs.

According to the first alternative of the first embodiment shown in FIG. 1A, the guide means 122, 186 for guiding the movement of the mobile part 12 between at least two stable positions are in the form of a sliding bearing. The mobile part 12 comprises a sliding zone 122 and the reference part 18 comprises a sliding zone 186, and they slide against one another so that the movement of the sliding zone 122 of the mobile part is guided along said sliding zone 186 of the reference part 18. In the example shown, the respective sliding zones 122, 186 and their shape allow for a movement of the mobile part 12 in a rectilinear direction. The actuator 10 shown in FIG. 1A is an actuator with linear movement.

Also according to the first alternative of the first embodiment shown in FIG. 1A, the support means 20, 22 of the mobile part 12 in each of the stable positions are in the form of projecting portion/recessed portion type contacts. The mobile part 12 is equipped, along its sliding zone 122, with at least two projecting portions 20 having a half-sphere shape. The reference part 18 is equipped, along its sliding zone 186, with at least two recessed portions 22. The projecting portions 20 and recessed portions 22 are aligned, respectively, in the direction of movement. In the example shown, the distance between two successive recessed portions 22 is shorter than the distance between two successive projecting portions 20. It can be equal or greater, depending on the desired movement for the mobile part 12.

Thus, after a movement caused by the relaxation or the contraction of the springs 14, 16, the mobile part 12 occupies successive positions that each correspond to a coincidence of one of the projecting portions (half-cylinder or half-sphere) 20 with one of the recessed portions (groove or cone) 22, and it is held in each of said coincidence positions until a subsequent movement takes place.

In the example shown in FIG. 1A, the projecting portions 20 are located on an elongate portion 126 of the mobile part 12, extending a body 125 thereof, and the recessed portions 22 are located on the reference part 18. A reverse configuration can be envisaged. For a bistable actuator, there are preferably two contacts 20, 22. For a multistable actuator, there are more than two contacts 20, 22.

In addition, the actuator can comprise means making it possible to provide permanent contact between the reference part 18 and the mobile part 12. These means can comprise a hole or a thinned portion 181 of the base of the reference part 18, by removing internal or external material, which enables the reference part 18 to pivot slightly under the action of the movement of the mobile part 12. Thus, permanent contact is provided between the reference part 18 and the mobile part 12 in a direction substantially perpendicular to the direction of movement of the mobile part 12.

FIG. 1B shows an alternative for implementing a portion of the actuator according to the first embodiment. Similarly to the first alternative shown in FIG. 1A, the body 125 of the mobile part 12 is aligned on one side with first movement means 14, and on the opposite side with second movement means 16 opposing the first movement means 14. In FIG. 1B, the same references designate the same constituent parts as in FIG. 1A.

Unlike in the first alternative shown in FIG. 1A in which the body 125 of the mobile part is in the form of a block, according to this alternative of FIG. 1B, the body 125 of the mobile part 12 comprises a plurality of slots 127. These are arranged substantially parallel to one another, and in a direction substantially perpendicular to the direction of movement of the mobile part 12. When they are seen in a cross-section in FIG. 1B, these slots 127 open alternately on two sides substantially opposite and parallel to one another. The presence of these slots 127 makes it possible to improve the thermal insulation between the two shape memory alloy-based movement means 14, 16 that are heated, as will be described below. However, these slots are thin enough not to cause the body 125 of the mobile part 12 to be deformed under the action of the movement means 14, 16.

Also according to this second alternative shown in FIG. 1B, the movement means 14, 16 are springs that are also in the form of blocks equipped with slots 147, 167, which are arranged substantially parallel to one another and in a direction substantially perpendicular to the direction of movement of the mobile part 12, and which open, in a cross-section view, alternately on two sides substantially opposite and parallel to one another. The slots 147, 167 are wide enough and close enough to one another to confer the necessary elastic deformation on the springs 14, 16.

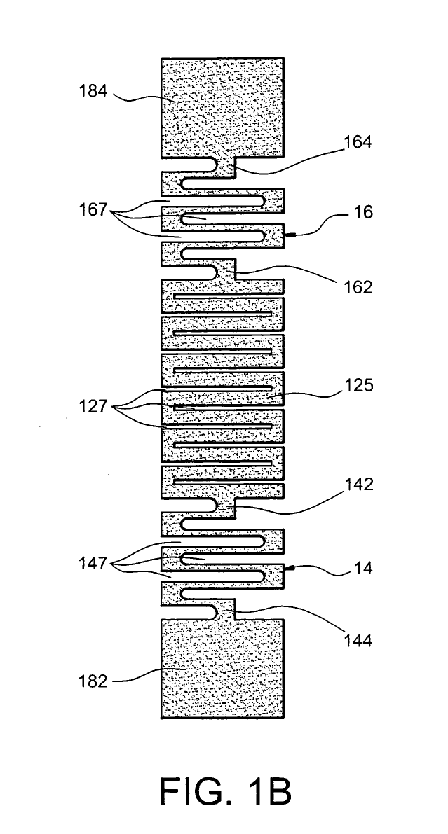

FIG. 2 shows a shape memory alloy-based actuator 10 according to the second embodiment of the first aspect of the invention, which differs from the actuator 10 according to the first embodiment by virtue of its guide means and its support means. Its other features are similar to those of the actuator according to the first alternative of the first embodiment, already described. Therefore, the description thereof will not be repeated.

According to the second embodiment, the guide means 24 comprise a plurality of elastic beams 24. These are arranged so as to be substantially parallel to one another in a direction substantially perpendicular to the direction of movement of the mobile part 12 when they are at rest.

They are connected by one of their ends 242 to the mobile part 12, and by the other of their ends 244 to the reference part 18 of the actuator 10. The two end connections of the elastic beams 24 are embedded.

According to a first alternative of the second embodiment shown in FIG. 2, there are two elastic beams 24 and they are both placed on the same side of the mobile part 12. They connect a connection zone 124 of the mobile part to a connection zone 188 of the reference part 18, which connection zones 124, 188 are substantially parallel to one another. Thus, the assembly formed by the two elastic beams 24, the connection zone 124 of the mobile part 12 and the connection zone 188 of the reference part 18 constitutes a four-bar or parallelogram-type planar hinge system, so that the elastic beams 24 and the respective connection zones 124 as thus arranged allow for a movement of the mobile part 12 in a rectilinear direction. The actuator 10 shown in FIG. 2 is an actuator with linear movement.

Also according to the first alternative of the second embodiment, the support means 28, 30 are in the form of projecting portion/recessed portion type contacts. The mobile part 12 is equipped with recessed portions 28 that cooperate with projecting portions 30 secured to the reference part 18 or to a stationary intermediate part in the environment thereof, so as to hold the mobile part in position 12.

In the example shown in FIG. 2, the recessed portions 28 are located on an elongate portion 126 of the mobile part 12, which is located in an extension of the connection zone 124 and of which the direction is substantially parallel to the direction of movement of the mobile part 12. They are arranged in pairs, so that the two recessed portions 28 of the same pair are located on two opposite sides of the elongate portion 126. In addition, two adjacent recessed portions 28 on the same side of the elongate portion 126 are separated by relief portions 32. The distance between two recessed portions 28 is chosen according to the desired movement for the mobile part 12. In the example shown, the recessed portions 28 are substantially in the form of slots, and the relief portions 32 are substantially in the form of half-spheres. The relief portions 30 can also have any other convex contour. The projecting portions 30 are preferably in the form of flexible blades 30, attached by one of their ends to the reference part 18 or to a stationary intermediate part in the environment thereof, with their other end remaining free. They are in pairs, and are arranged so that their free ends are opposite one another leaving a given space therebetween. This space is intended to allow the elongate portion 126 of the mobile part to slide between the flexible blades 30, with a movement causing the two flexible blades 30 to bend.

Thus, after a movement caused by the relaxation or contraction of the springs 14, 16, the mobile part 12 occupies successive positions that each correspond to a coincidence of two recessed portions (slots) 28 located at the same level, respectively on two opposite surfaces of the elongate portion 126, with the free ends of the two flexible blades 30, and it is held in each of the coincidence positions until a subsequent movement takes place.

For a bistable actuator, there are preferably two contacts 28, 30. For a multistable actuator, there are more than two contacts 28, 30.

According to a second alternative of the second embodiment (not shown), there are more than two elastic beams 24 present and they are arranged on either side of the mobile part.

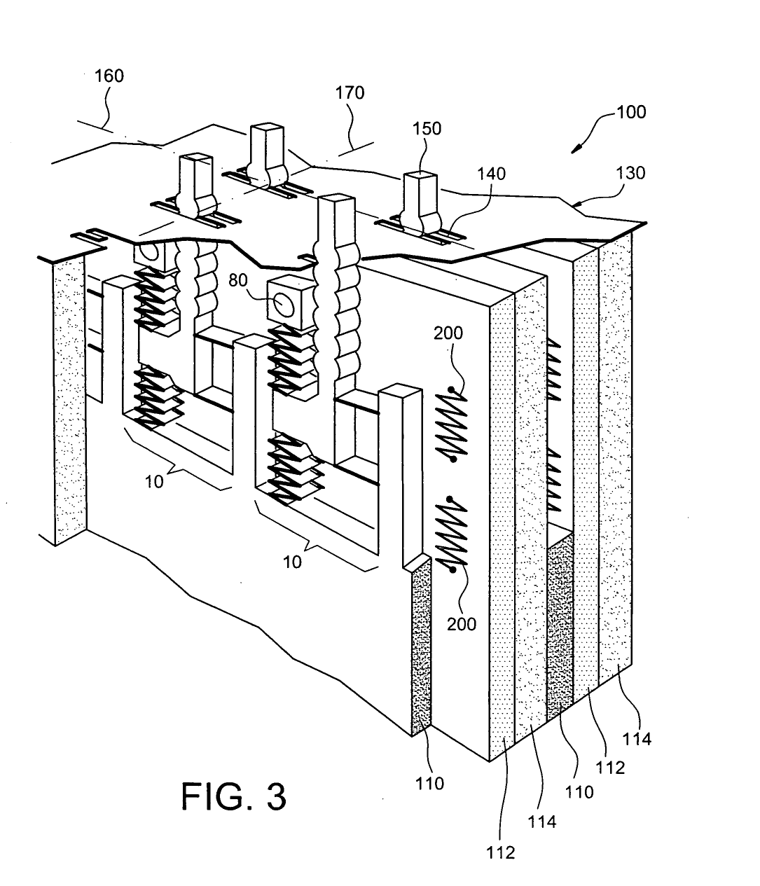

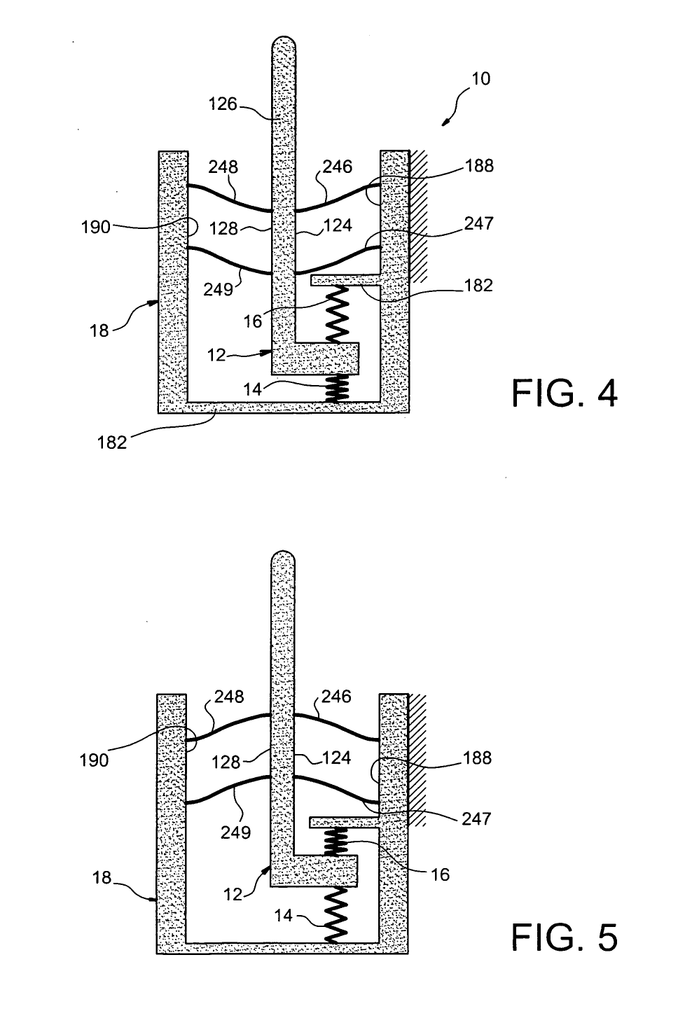

FIGS. 4 and 5 show a shape memory alloy-based actuator 10 according to the third embodiment of the first aspect of the invention, which differs from the actuator 10 according to the second embodiment by virtue of its guide means and its support means. Its other features are similar to those of the actuator according to the second embodiment, already described. Therefore, the description thereof will not be repeated.

According to the third embodiment, the guide means comprise a plurality of elastic beams 246, 247, 248, 249, arranged so as to be substantially parallel to one another in a direction substantially perpendicular to the direction of movement of the mobile part 12 when they are at rest.

The elastic beams are connected by one of their ends to the mobile part 12, and by the other of their ends to the reference part 18 of the actuator 10. The two end connections of the elastic beams 246, 247, 248, 249 are embedded. According to this embodiment, the reference part 18 is stationary.

The elastic beams 246, 247, 248, 249 are combined into a first pair 246, 247, arranged on a first side of the mobile part 12, and a second pair 248, 249, arranged on a second side thereof. The first pair 247, 247 connects a first connection zone 124 of the mobile part 12 to a first connection zone 188 of the reference part 18, while the second pair 248, 249 connects a second connection zone 128 of said mobile part 12 to a second connection zone 190 of said reference part 18. The connection zones 124, 188, 128, 190 are substantially parallel to one another.

Thus, the assembly formed by the two elastic beams 246, 247 of the first pair, the first connection zone 124 of the mobile part 12 and the first connection zone 188 of the reference part 18 constitutes a first four-bar or parallelogram-type planar linkage system. Similarly, the assembly formed by the two elastic beams 248, 249 of the second pair, the second connection zone 128 of the mobile part 12 and the second connection zone 190 of the reference part 18 constitutes a second four-bar or parallelogram-type planar hinge system.

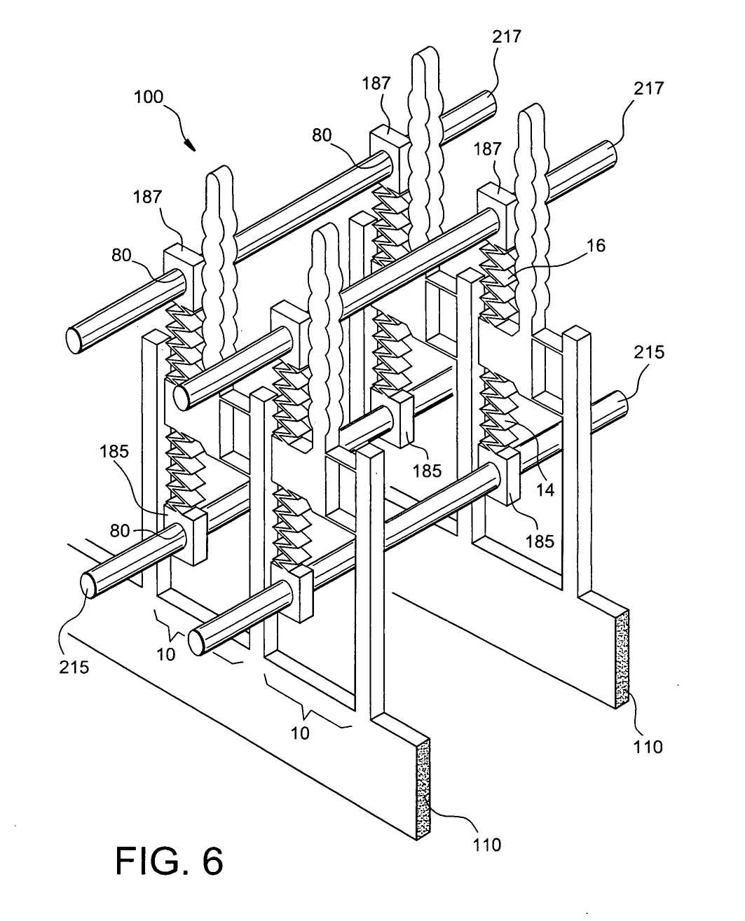

The result is that the elastic beams 246, 247, 248, 249 and the respective connection zones 124, 188, 128, 190 thus arranged allow for a movement of the mobile part 12 in a rectilinear direction. The actuator 10 shown in FIGS. 6 and 7 is an actuator with linear movement.

Because the ends of the beams 246, 247, 248, 249 are embedded in the reference part 18, which is stationary, the buckling of the four pre-stressed beams 246, 247, 248, 249 allows for the movement of the mobile part 12, between two positions. The actuator 10 is, in this third embodiment, a bistable actuator.

The guide means 246, 247, 248, 249 of the mobile part 12 also serve as support means for said mobile part 12. Therefore, it is not necessary, in this third embodiment, to have additional support means such as the projecting portion/recessed portion type contacts of the first and second embodiments of the actuator according to the invention.

In the example shown in FIGS. 4 and 5, the two parallelogram-type hinge systems 246, 247, 124, 188 and 248, 249, 128, 190 are both substantially located in the same plane. In a functionally equivalent manner, they may be located in two different planes creating a given angle therebetween. It is also possible to envisage more than two pairs of beam and corresponding connection zones, and there would thus be more than two parallelogram-type linkage systems.

The functioning of an actuator according to the invention will now be described in reference to FIGS. 4 and 5. The actuator 10 shown is that of the third embodiment, but its operation is similar to that of the other embodiments and alternatives of the actuator according to the invention.

FIG. 4 corresponds to a configuration of the actuator in which the mobile part 12 is in the low position. The movement means, i.e. the coil springs 14, 16, are stressed: spring 14 is contracted, while spring 16 is relaxed. The guide and support means 246, 247, 248, 249 are also stressed by buckling.

One of the shape memory alloy-based movement means is heated and adopts its other memorised shape: the upper spring 16 in FIG. 5 contracts. It simultaneously deforms the other opposing movement means: the lower spring 14 in FIG. 5 relaxes. However, the two springs 14, 16 are aligned and arranged on either side of a portion of the mobile part 12. In addition, they each have an end 144, 164 attached to a base 182 of the reference part 18 and the other end attached to the mobile part 12. Consequently, the combined movements of contraction of one of the springs 16 and relaxation of the other spring 16 move the portion of the mobile part 12 located between them, and therefore move the entire mobile part 12: it is moved upward in FIG. 5. Each of the flexible beams 246, 247, 248, 249 is embedded at its two ends, respectively in the reference part 18 and in the mobile part 12. Consequently, it is deformed by buckling so as to accompany the movement of the mobile part 12 with respect to the reference part 18.

If the heating of the movement means 16 is stopped, the mobile part remains in the position in which it was moved, and is held in this position by the combined action of the flexible beams 246, 247, 248, 249.

To move the mobile part 12 in the reverse direction, the second movement means, which have been stressed, are heated so that they return to their initial form.

The springs can be made of a one-way shape memory alloy or a two-way shape memory alloy. In particular, it is possible to combine two one-way shape memory springs to form a two-way shape memory spring.

The actuators 10 which have just been described in reference to FIGS. 1A, 1B, 2, 4 and 5 are made of a single piece by cutting from a shape memory alloy-based one-piece structure.

Such a production from a one-piece structure has a certain number of advantages. Indeed, it is easy to produce the actuator. To do this, it is simply necessary to implement a cutting method in order to quickly and inexpensively obtain actuators having very specifically determined shapes and sizes. The cutting methods can comprise laser cutting or waterjet cutting or electrical discharge machining or electrolithography, or cathode spray deposition of a shape memory alloy. Similarly, as will be described below, it is possible to thus produce an assembly of actuators in series in a single initial volumic structure. Among the elements constituting these actuators, at least the opposing movement means 14, 16 have undergone a treatment conferring one-way shape memory properties thereon.

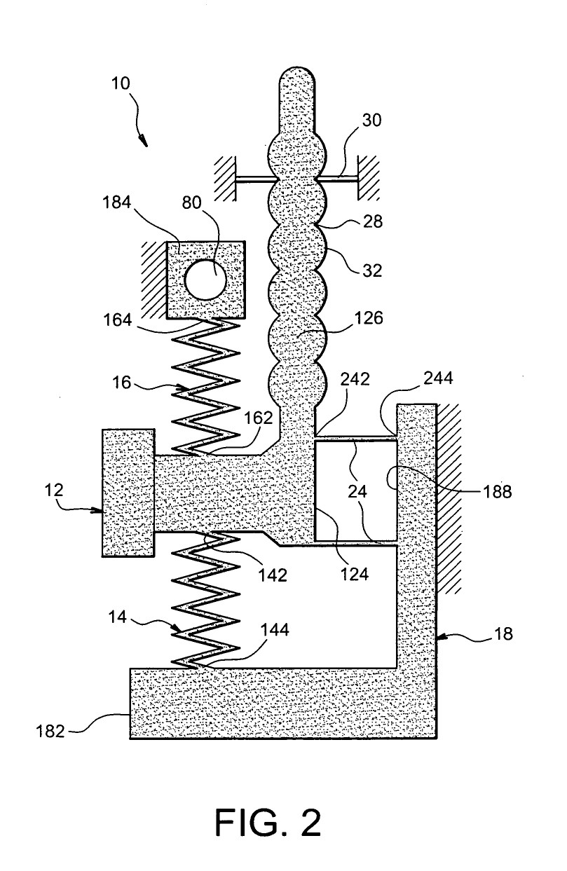

FIGS. 3 and 6 show an interface 100 according to the second aspect of the invention comprising a plurality of actuators 10 according to the first aspect of the invention.

The actuators 10 shown correspond to the first alternative of the second embodiment, but it is possible to envisage an interface comprising actuators 10 according to other embodiments and alternatives consistent with the first aspect of the invention.

In FIG. 3, the interface 100 comprises a plurality of plates, comprising first plates 110, second plates 112 and third plates 114.

The first plates 110 are shape memory alloy-based plates in which, for example by a cutting method as described above, actuators 10, such as those described above, are cut so that the actuators 10 are arranged side-by-side along each of the first plates 110.

The second plates 112 are plates made of a heat-insulating material, such as PVC, for example, in which heating means, constituted in this example by heating resistors 200, are regularly distributed.

The third plates 114 are separation plates made of a heat-insulating material, such as PVC, for example, which serve to maintain a uniform distance between the respective actuators of two adjacent first plates 110.

The first plates 110, second plates 112 and third plates 114 are arranged in connection in this order and in a repeated manner, so that the heating resistors 200 of the second plates 112 are opposite movement means 14, 16 of the actuators 10 of the first plates 110. In the example shown, the attachment parts 184 of the actuators 10 are attached to the second plates 112 by appropriate attachment means through attachment holes 80.

A thin plate or sheet made of a flexible material 130 covers the assembly of sections of the first, second and third plates 110, 112, 114 thus assembled in connection. In the sheet 130, holes 140 are cut at regular intervals in two directions 160, 170 substantially perpendicular to said sheet 130, so as to form a matrix pattern. The holes 140 are arranged so that they are located above the free ends 150 of the elongate portions 126 of the mobile parts 12 of the actuators 10.

In the example of FIG. 3, the holes 140 have a contour that has, from a top view, an H-shape, and which defines two tabs arranged opposite one another, of which the free ends face one another. These tabs constitute flexible blades 30 that are secured to the sheet 130, which is considered to be a stationary intermediate part forming part of the environment of the actuators 10. These flexible blades 30 have a function of support means for the actuators 10 according to the second embodiment, which are cut in the first plates 110.

It is possible to envisage a sheet 130 in which holes 140 are cut and have regular, for example circular or quadrangular, contours. Such a sheet 130 is more appropriate for first plates 110 having actuators 10 according to the first embodiment, for which the support means are not located toward the free end 150 of the elongate portion 126 of the mobile part 12.

When heating means are heating resistors 200, as in the example shown in FIG. 3, the interface also includes power supply means (not shown) for supplying the electrical current to said heating resistors.

FIG. 6 is a figure analogous to FIG. 3, which shows an interface 100 according to the second aspect of the invention, and which illustrates a preferred alternative embodiment of the heating means. To simplify the understanding of the figure, the sheet 130 has been omitted. Only the differences between this interface and that interface already described in reference to FIG. 3 will be described. The interface 100 comprises a plurality of plates 110, based on a shape memory alloy. These plates are mutually parallel shape memory alloy-based plates, in which actuators 10 arranged side-by-side are cut.

The reference part 18 in this case comprises a low portion 185 and a high portion 187, which are both equipped with an attachment hole 80.

The plates 110 are arranged parallel to one another without intermediate plates 112, 116. The actuators 10, mutually aligned on the parallel plates 110, are connected to one another by means of first connecting rods 215, which pass through all of the attachment holes 80 of all of the low portions 185 for the same line of actuators 10, and by means of second connecting rods 217, which pass through all of the attachment holes of all of the high portions 187 for the same line of actuators 10. The connecting rods are themselves rigidly attached at their ends (not shown).

According to this embodiment of the interface 100, the material constituting the connecting rods 215, 217 is chosen so that it is an electrically conductive material. Thus, the movement means 14, 16 are directly heated by the Joule effect.

### REFERENCES CITED

[1]: U.S. Pat. No. 6,242,841
[2]: U.S. Pat. No. 6,326,707
[3]: W. Brenner, S. Mitic, A. Vujanic, G. Popovic, “Micro-actuation principles for high-resolution graphic tactile displays”, Proceeding of Eurohaptics, 2001, p. 55-58.

1-18. (canceled)

19: Multistable actuator, comprising:
a mobile part intended to be moved between at least two stable positions,
opposing movement means for moving said mobile part,
guide means for guiding the movement of said mobile part, and
support means for holding the mobile part in each of the stable positions that it occupies,
wherein said movement means are two opposing movement means, each made of a shape memory alloy,
and wherein the mobile part, the movement means and the guide means are produced in the form of a shape memory alloy-based one-piece structure, of which at least the movement means have been subjected to a treatment conferring shape memory properties thereon.

20: Actuator according to claim 19, wherein the mobile part, the movement means, the guide means, and the support means are produced in the form of a shape memory alloy-based one-piece structure, of which at least the movement means have been subjected to a treatment conferring shape memory properties thereon.

21: Actuator according to claim 19, wherein said movement means are made of a shape memory alloy belonging to the group consisting of Ni—Ti, Ni—Ti—Cu, Cu—Al—Ni, Cu—Al—Be, Fe—Pt, Fe-Rd or Fe—Ni—Co—Ti.

22: Actuator according to claim 19, wherein the two opposing movement means are made of a single two-way shape memory alloy.

23: Actuator according to claims 19, wherein guide means, and the support means constitute an integrated stepper mechanism.

24: Actuator according to claim 19, wherein it is an actuator with rotary movement.

25: Actuator according to claim 19, wherein it is an actuator with linear movement.

26: Actuator according to claim 19, wherein the guide means comprise at least one sliding bearing and the support means comprise projecting portions in one of the two parts among the mobile part and a reference part, and recessed portions in the other of these parts.

27: Actuator according to claim 19, wherein said guide means comprise a plurality of elastic beams and the support means comprise recessed portions in the mobile part and projecting portions in a reference part.

28: Actuator according to claim 19, wherein the projecting portions are flexible blades.

29: Actuator according to claim 19, wherein the one-piece structure is made from a shape memory alloy-based planar part by means of a laser cutting method.

30: Actuator according to claim 19, wherein the one-piece structure is made from a shape memory alloy-based planar part by means of an electrical discharge machining method, electrolithography, cathode spray deposition or waterjet cutting.

31: Actuator according to claim 19, wherein it is a bistable actuator in which the mobile part moves between two stable positions.

32: Actuator according to claim 19, wherein the guide means and the support means are merged and consist of pre-stressed embedded beams of which the buckling enables the mobile part to move.

33: Tactile interface, wherein it implements at least one one-piece structure comprising a plurality of multistable actuators comprising:
a mobile part intended to be moved between at least two stable positions,
opposing movement means for moving said mobile part, guide means for guiding the movement of said mobile part, and
support means for holding the mobile part in each of the stable positions that it occupies,
wherein said movement means are two opposing movement means, each made of a shape memory alloy,
and wherein the mobile part, the movement means and the guide means are produced in the form of a shape memory alloy-based one-piece structure, of which at least the movement means have been subjected to a treatment conferring shape memory properties thereon.

34: Interface according to claim 33, wherein it also includes heating means for heating the shape memory alloy-based movement means.

35: Interface according to claim 34, wherein said heating means comprise heating resistors.

36: Interface according to claim 34, wherein said heating means comprise electrically conductive rods.
